(19) United States
(12) Patent Application Publication
(10) Pub. No.: US 2006/0196874 A1
(43) Pub. Date: Sep. 7, 2006

(54) Trash can with sensor

(76) Inventor: Frank Yang, Rancho Palos Verdes, CA (US)

Correspondence Address: Raymond Sun, 12420 Woodhall Way, Tustin, CA, 92782, US

(21) Appl. No.: 11/074,140

(22) Filed: Mar. 7, 2005

(51) Int. Cl. B65D 55/00; G05B 5/00

(52) U.S. Cl. 220/211; 318/482

(57) ABSTRACT

A trash can assembly has an outer shell, a lid pivotably coupled to the top end of the outer shell, a sensor positioned inside a covered region defined by the outer shell, and a lid control system coupling the sensor and the lid. The lid control system opens and closes the lid when the sensor is actuated.

### BACKGROUND OF THE INVENTION

1. Field of the Invention

The present invention relates to trash can assemblies, and in particular, to a trash can assembly that has a sensor that can be activated to automatically open the lid.

2. Description of the Prior Art

A major concern for both the home and the workplace is containing and holding wastes, refuse, and trash until permanent disposal. Trash cans act as containers for holding trash and other wastes that are produced in any typical home or office. Trash and garbage cans often employ lids and covers to contain the trash and its associated odor, to hide the trash from view, and to prevent the trash from contaminating areas beyond the lid.

Conventional trash cans have been improved over the years to make them more user-friendly, sanitary, and hygienic. For example, many trash cans are now provided with a sensor that is positioned on the lid. The sensor is activated by infrared when the user waves a hand near the sensor, and the activation will cause the lid to open. However, these conventional trash cans still suffer from a number of drawbacks.

For example, the sensitivity of the sensor presents a tricky issue. Particularly sensitive sensors will cause the lid to open when any human being is in close proximity to the lid (on which the sensor is positioned), resulting in the accidental opening of the lid, which can be annoying. Such unnecessary opening of the lid exposes the immediate environment to the trash contained in the trash can, and increases the wear and tear on the sensor and the lid. In addition, a lid that opens accidentally may inadvertently hit a user's body, and drains the batteries that are provided to power the trash can assembly.

On the other hand, insensitive sensors are also undesirable because the user may need to extend his or her hand towards the sensor until the hand almost touches the sensor. This creates two problems. First, a user whose hands are full (or otherwise occupied) will not be able to conveniently extend a finger to almost touch the sensor. Second, if the user's hand gets too close to the sensor on the lid, the lid will hit the user's hand when the lid opens.

Thus, there remains a need for a trash can assembly that overcomes the drawbacks identified above.

### SUMMARY OF THE DISCLOSURE

In order to accomplish the objects of the present invention, there is provided a trash can assembly that has an outer shell, a lid pivotably coupled to the top end of the outer shell, a sensor positioned inside a covered region defined by the outer shell, and a lid control system coupling the sensor and the lid. The lid control system opens and closes the lid when the sensor is actuated.

### BRIEF DESCRIPTION OF THE DRAWINGS

FIG. 1 is a front perspective view of a trash can assembly according to one embodiment of the present invention shown with the lid opened.

FIG. 2 is a front perspective view of a trash can assembly according to another embodiment of the present invention shown with the lid opened.

FIGS. 3A-3C are side plan views illustrating the operation of the assembly of FIG. 1.

FIG. 4 is a front plan view of a trash can assembly according to another embodiment of the present invention.

FIG. 5 is a side plan view of the trash can assembly of FIG. 4.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

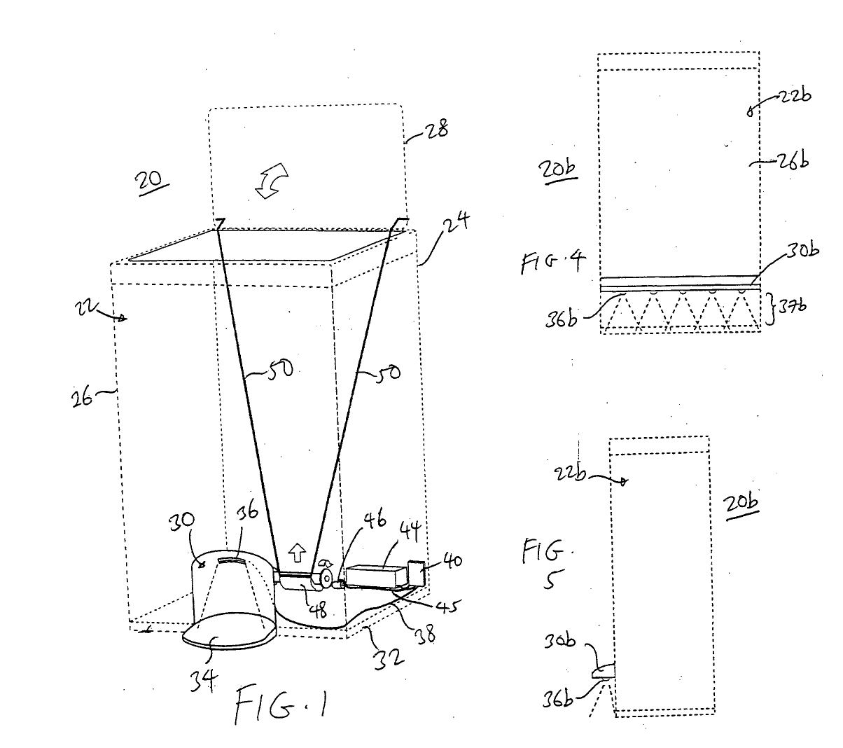

FIG. 1 illustrates one embodiment of a trash can assembly 20 according to the present invention. The assembly 20 has an outer shell 22 and an inner liner (not shown) that is adapted to be retained inside the outer shell 22.

The outer shell 22 can assume any configuration. As a non-limiting example, FIG. 1 illustrates the outer shell 22 as having a generally four-sided configuration with a rear wall 24 and a front wall 26. The inner liner can have the same, or different, shape as the outer shell 22. A lid 28 is pivotably connected to the top edge of the rear wall 24 via any conventional hinged connection that is well-known in the art.

A foot recess 30 can be provided on the outer shell 22 adjacent the bottom 32 of the outer shell 22. The recess 30 can be formed as part of the outer shell 22, and defines a covered region. The recess 30 extends into the interior confines of the outer shell 22 (as defined by the periphery of the outer shell 22). The recess 30 also extends upwardly for a short distance from the bottom 32. A foot plate 34 can be provided at the bottom of the recess 30, and can extend from the bottom 32 of the outer shell 22. A sensor 36 is provided adjacent an upper portion of the recess 32 in a position where the sensor 36 is covered by the recess 32.

The sensor 36 functions to detect the presence of a foot or other object that is inserted into the recess 30. The sensor 36 can be embodied in the form of any sensor that is well-known in the art, and can be an infrared sensor. Thus, the sensor 36 can be actuated by a user extending a foot (or other object) into the space defined by the recess 30. The sensor 36 is coupled to a lid control system that functions to control the opening and closing of the lid 28. The lid control system includes wiring 38 provided inside the outer shell 22 to couple the sensor 36 to a circuit board 40, which is in turn coupled via a wiring 45 to a motor gear 46 that drives a rotary lifting bar 48. Batteries 44 can be coupled to the circuit board 40 and the motor gear 46. The lid control system further includes a pair of link rods 50 that extend vertically adjacent and along the rear wall 24. Each rod 50 has a first end that is coupled to the lifting bar 48, and an opposite second end that is coupled to the lid 28. The circuit board 40, batteries 44, motor gear 46 and lifting bar 48 are illustrated as being positioned adjacent the bottom 32 and inside the outer shell 22, but these elements can actually be positioned anywhere inside or outside the outer shell 22.

The circuit board 40 has a control circuit that functions to control the operation of the motor gear 46, and the opening and closing motions of the lid 28. The control circuit can be implemented using circuit designs that are well-known to those skilled in the art. The motor gear 46 can be driven in two opposite directions so that the motor gear 46 can also turn the lifting bar 48 in two opposite directions. When the lifting bar 48 rotates in a first direction, the link rods 50 will move upwardly to push the lid 28 open, and when the lifting bar 48 rotates in an opposing second direction, the link rods 50 will move downwardly to pull the lid 28 closed.

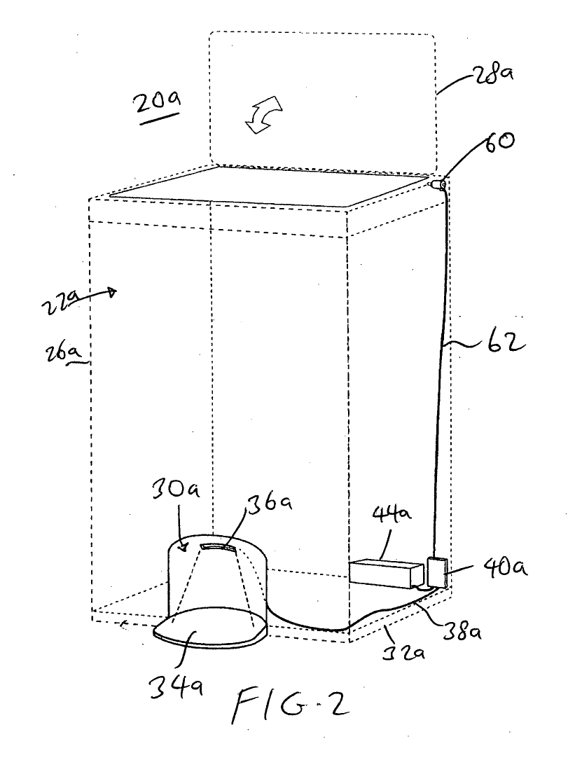

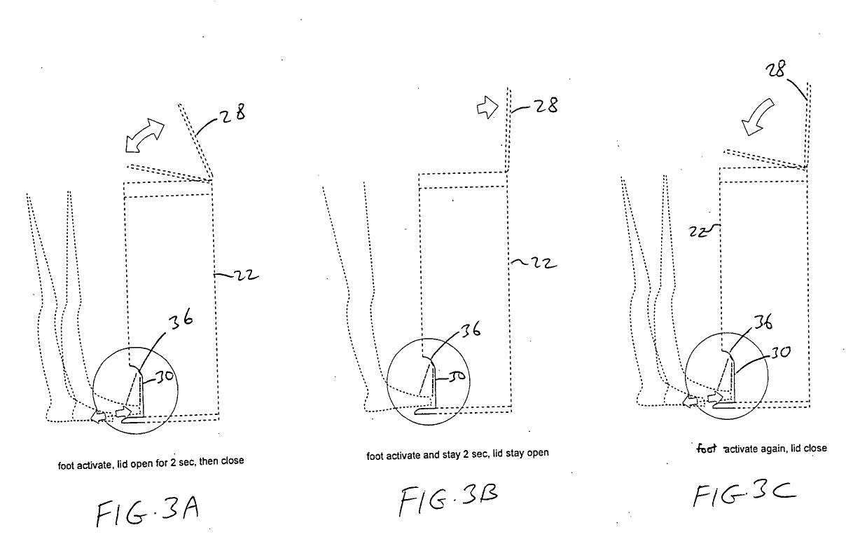

FIGS. 3A-3C illustrate the operation of the opening and closing of the lid 28 of the trash can assembly 20. With the lid 28 in the closed position, the sensor 36 will be actuated when a user inserts a foot (or other object) into the recess 30 into the path of the sensor 36. The actuation of the sensor 36 will cause the control circuit in the circuit board 40 to drive the motor gear 46 in the required direction to rotate the lifting bar 48 in the first direction to open the lid 28. If the user immediately removes the foot (or other object) from the recess 30 (see FIG. 3A), then the lid 28 will remain opened for a specific period of time (e.g., two seconds), and then the control circuit in the circuit board 40 will drive the motor gear 46 in the opposite direction to rotate the lifting bar 48 in the second direction to close the lid 28. However, if the user's foot (or other object) remains in the recess 30 (see FIG. 3B) for more than a specific period of time (e.g., two seconds), then the control circuit in the control board 40 will maintain the lid 28 in the opened position indefinitely. In the situation shown in FIG. 3B, the user will eventually remove the foot (or other object). After the foot has been removed in the FIG. 3B situation, if the foot (or other object) is then re-inserted into the recess 30 into the path of the sensor 36 (see FIG. 3C), then the control circuit in the circuit board 40 will drive the motor gear 46 in the opposite direction to rotate the lifting bar 48 in the second direction to close the lid 28.

FIG. 2 illustrates another embodiment of a trash can assembly 20a according to the present invention. The assembly 20a is similar to the assembly 20 of FIG. 1, so the same elements in FIGS. 1 and 2 have the same numeral designations except that an “a” is added to the designations in FIG. 2. The difference between the assemblies 20 and 20a is that the assembly 20a has a different lid control system that is used to open and close the lid 28a after the sensor 36a has been actuated. Specifically, the motor gear 46 and rods 50 in the assembly 20 are replaced by a motor hinge 60 and wiring 62 that couples the circuit board 40a to the motor hinge 60. The motor hinge 60 functions to open and close the lid 28a by turning the hinged connection of the lid 28a in the requisite direction. The motor hinge 60 can be embodied in the form of any motor hinge that is well-known in the art. The operations described in connection with FIGS. 3A-3C can also be performed by the assembly 20a, with the control circuit in the control board 40a programmed to control the motor hinge 60 in the same manner as for the motor gear 46.

By positioning the sensor 36, 36a inside a recess 30, 30a, the sensor 36, 36a cannot be accidentally actuated. To actuate the sensor 36, 36a, the user must deliberately insert a foot (or other object) or other object into a recess 30, 30a which is located very close to the ground. While this will not eliminate accidental actuation of the sensor 36, 36a, it allows for a highly sensitive sensor to be used while significantly minimizing accidental actuation of the sensor 36, 36a and the subsequent opening of the lid 28, 28a.

Notwithstanding the above, it is also possible to omit the recess 30, 30a. For example, FIGS. 4 and 5 illustrate a trash can assembly 20b that can be identical to the trash can assembly 20a except that the front wall 26b does not have a recess. Instead, a canopy 30b extends from the periphery of the front wall 26b to define a covered region 37b. A plurality of sensors 36b can be provided in spaced-apart manner on the underside of the canopy 30b. In other words, any number (e.g., one or more) of sensors 36b can be provided, depending on the length of the canopy 30b and the desired use. Providing a greater number of sensors 36b will allow the user to actuate one of the sensors 36b more easily because the user only needs to place the foot (or other object) in the direct path of any of the sensors 36b, while providing a single sensor 36b requires that the user place the foot (or other object) in the direct path of the single sensor 36b. The plurality of sensors 36b can be coupled via wiring (not shown, but can be the same as 38a) to a circuit board (not shown, but can be the same as 40a).

Thus, the embodiment illustrated in FIGS. 4 and 5 provides a covered region 37b adjacent the bottom of the outer shell 22b where the user can actuate one or more sensors 36b. The embodiment illustrated in FIGS. 4 and 5 also illustrates the provision of more than one sensor 36b, and the same principle can be applied to FIGS. 1 and 2, where a plurality of sensors 36, 36a can be provided in the respective recess 30, 30a. As an alternative, the canopy 30b can be provided along a side wall (e.g., 35b) of the outer shell 22b instead of along the front wall 26b.

The above detailed description is for the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices, components, mechanisms and methods are omitted so as to not obscure the description of the present invention with unnecessary detail.

What is claimed is:

1. A trash can assembly, comprising:
an outer shell having an enclosing wall, a top end, a bottom end, and a front wall;
a lid pivotably coupled to the top end;
a sensor positioned on the front wall adjacent the bottom end; and
a lid control system coupling the sensor and the lid, the lid control system opening the lid when the sensor is actuated.

2. The assembly of claim 1, further including a recess provided in the front wall adjacent the bottom end, with the sensor positioned inside the recess.

3. The assembly of claim 2, wherein the recess extends inwardly from the front wall.

4. The assembly of claim 1, further including a canopy that extends from the front wall adjacent the bottom end, with the sensor positioned under the canopy.

5. The assembly of claim 1, wherein the sensor includes a plurality of sensors.

6. The assembly of claim 1, wherein the lid control system includes:
a circuit board coupled to the sensor;
a motor gear coupled to the circuit board;
a lifting bar coupled to the motor gear; and
a link rod having one end coupled to the lid and another end coupled to the lifting bar.

7. The assembly of claim 1, wherein the lid control system includes:
a circuit board coupled to the sensor; and
a motor hinge coupled to the circuit board, the motor hinge operationally coupled to the lid.

8. A trash can assembly, comprising:
an outer shell having an enclosing wall, a top end, a bottom end, and a covered region defined on a portion of the wall;
a lid pivotably coupled to the top end;
a sensor positioned in the covered region; and
a lid control system coupling the sensor and the lid, the lid control system opening the lid when the sensor is actuated.

9. The assembly of claim 8, wherein the covered region is defined by a recess provided in a front wall of the outer shell adjacent the bottom end.

10. The assembly of claim 9, wherein the recess extends inwardly from the front wall.

11. The assembly of claim 8, wherein the covered region is defined by a canopy that extends from a front wall of the outer shell adjacent the bottom end, with the sensor positioned under the canopy.

12. The assembly of claim 8, wherein the sensor includes a plurality of sensors.

13. The assembly of claim 8, wherein the lid control system includes:
a circuit board coupled to the sensor;
a motor gear coupled to the circuit board;
a lifting bar coupled to the motor gear; and
a link rod having one end coupled to the lid and another end coupled to the lifting bar.

14. The assembly of claim 8, wherein the lid control system includes:
a circuit board coupled to the sensor; and
a motor hinge coupled to the circuit board, the motor hinge operationally coupled to the lid.

15. A method of opening and closing a lid of a trash can assembly, comprising:
providing an outer shell having a top end, and a bottom end;
providing a lid pivotably coupled to the top end;
providing a sensor adjacent the bottom end;
placing an object in the vicinity of the sensor to actuate the sensor and open lid;
maintaining the object in the vicinity of the sensor to keep the lid open;
removing the object from the vicinity of the sensor; and
placing the object in the vicinity of the sensor to actuate the sensor and close lid.
